(19) United States
(12) Patent Application Publication
(10) Pub. No.: US 2012/0140275 A1
(43) Pub. Date: Jun. 7, 2012

(54) SCAN MANAGEMENT SYSTEM, SCAN MANAGEMENT APPARATUS, CONTROLLING METHOD OF SCAN MANAGEMENT SYSTEM, AND RECORDING MEDIUM

(75) Inventor: Naoyuki Fukuda, Misato-shi (JP)

(73) Assignee: CANON KABUSHIKI KAISHA, Tokyo (JP)

(21) Appl. No.: 13/307,099

(22) Filed: Nov. 30, 2011

(30) Foreign Application Priority Data
Dec. 1, 2010 (JP) 2010-268685
Oct. 31, 2011 (JP) 2011-238508

(51) Int. Cl. G06F 15/00

(52) U.S. Cl. 358/1.15

(57) ABSTRACT

Scan information which is to be used to generate a scan ticket for instructing a scan of a paper document and includes position information of a portable terminal is transmitted to a scan ticket server, the scan ticket is generated from the received scan information by the scan ticket server, the generated scan ticket is transmitted to an image processing apparatus, a scanned image of the paper document and attribute information including the position information are generated based on the scan ticket by the image processing apparatus, and the scanned image and the generated attribute information are transmitted to a map management server.

### BACKGROUND OF THE INVENTION

1. Field of the Invention

The present invention relates to a scan management system in which it is possible to instruct an image processing apparatus to perform image reading. More specifically, the present invention relates to the scan management system which can associate position information indicating where one has gone to (hereinafter, called an outside location) with scanned data, a scan management apparatus to be used in the scan management system, a controlling method for the scan management system, and a recording medium for recording a program of the controlling method.

2. Description of the Related Art

Conventionally, an image processing apparatus scans a paper document to obtain a scanned image, converts the scanned image into electronic data, and transmits the converted electronic data to a client terminal or a server. Then, the transmitted electronic data is stored in the client terminal or the server. In this case, the stored electronic data (scanned data) can be called and referred by a user when needed. Moreover, since the paper document is scanned and converted into the scanned data, various kinds of information can be added thereto. Thus, it is possible to make complicated managements of the paper documents efficient by properly using the added information.

In general, it is often the case that various kinds of paper documents are received at outside locations. For example, an outside salesperson often receives various paper materials, information and documents at customers, and a passerby receives various advertisement handbills and the like on a street. In these cases, if the received paper documents are directly held as it is, some documents may be missed, and/or the accumulated paper documents become voluminous. As a result, it becomes difficult to properly manage the received paper documents as a whole. Consequently, the received paper documents are scanned and converted into the scanned data in the image processing apparatus, so as to efficiently manage these documents.

For example, Japanese Patent Application Laid-Open No. 2004-310463 discloses a technique of managing scanned data obtained by scanning paper documents. In this technique, a digital watermark or the like for assuring genuineness is added to a scanned and thus generated electronic document, the obtained electronic document is stored in an electronic document storage apparatus, and information concerning the stored electronic document is stored to an electronic document management database. Then, when a paper document is registered in a paper document management apparatus and management information of the paper document is stored in a paper document management database, the electronic document and information of the paper document are associated with each other by the electronic document management apparatus.

However, when the paper document is received at an outside location, there is a case where it is important to know where the paper document was received. For example, when a user such as a salesperson or the like received paper documents respectively at a plurality of customers in a day, there is a case where the user wishes to record what kind of document was received at which customer.

Moreover, even if the user remembers where the paper document was received, when the information indicating the place where the user received the paper document is added to scanned data, it is necessary to associate the position information indicating the place where the user received the paper document with the electronic data obtained by scanning the paper document, whereby there is a problem of requiring additional works.

Moreover, there is a case where it is desired to know whether or not a material was received from a customer at an outside location. In particular, there is a case where a trouble as to whether or not the material was received arises between a user such as a salesperson and the customer. In addition, when the material is an important document such as a contract, there is a case where it is important to know who currently holds the material. Therefore, it is necessary to manage such information as above. However, there is conventionally a problem that the information like this cannot appropriately be managed because it only depends on only memories of the persons in charge.

### SUMMARY OF THE INVENTION

The present invention has been completed to solve the above-described conventional problems, and a first object of the present invention is to provide a mechanism of easily managing scanned data obtained by image reading, by adding position information at an outside location to the scanned data.

Moreover, a second objection of the present is to provide a mechanism capable of easily knowing and managing whether a paper document was received at an outside location.

To achieve the above objects, there is provided a scan management system which includes an information processing terminal comprising a position information obtaining unit adapted to obtain position information indicating a current location of an information processing terminal and a position information transmitting unit adapted to transmit the position information obtained by the position information obtaining unit to a scan management apparatus, an image processing apparatus adapted to generate scanned data by reading a paper document, and the scan management apparatus comprising a memory unit adapted to store the scanned data and the position information corresponding to the scanned data, wherein: the scan management apparatus comprises, a position information receiving unit adapted to receive the position information transmitted by the position information transmitting unit, an identification information transmitting unit, in a case where the position information is received by the position information receiving unit, adapted to transmit identification information for associating the position information and the scanned data with each other to the image processing apparatus, and a scanned data storage unit, in a case where the scanned data generated by the image processing apparatus and the identification information transmitted by the identification information transmitting unit are received from the image processing apparatus, adapted to store, in the memory unit, the received scanned data and the position information corresponding to the received identification information, while associating the scanned data and the position information with each other; and the image processing apparatus comprises a scanned data transmitting unit adapted to receive the identification information transmitted by the identification information transmitting unit, and transmit the scanned data generated by reading the paper document and the received identification information to the scan management apparatus.

Further features of the present invention will become apparent from the following description of exemplary embodiments with reference to the attached drawings.

### BRIEF DESCRIPTION OF THE DRAWINGS

FIG. 1 a configuration diagram illustrating an example of a scan management system according to an embodiment of the present invention.

FIG. 2 is a block diagram illustrating an example of a hardware constitution of each of an authentication server, a scan ticket server, a map management server, a client terminal and a portable terminal.

FIG. 3 is a block diagram illustrating an example of a hardware constitution of an image processing apparatus.

FIG. 4 is a block diagram illustrating an example of module constitutions of the authentication server, the scan ticket server, the map management server, the client terminal and the portable terminal.

FIG. 5 is a schematic diagram illustrating an outline of a process according to the embodiment of the present invention.

FIG. 6 is a schematic diagram illustrating an outline of a process according to the embodiment of the present invention.

FIG. 7 is a flow chart indicating a process of issuing a scan ticket at an outside location by using the portable terminal, the scan ticket server and the authentication server.

FIG. 8 is a flow chart indicating a process of converting a paper document into a scanned image and registering the scanned image by using a card reader, the image processing apparatus, the authentication server and the scan ticket server.

FIG. 9 is a flow chart indicating a process of associating a scanned image with map information by using the image processing apparatus and a map management server.

FIG. 10 is a flow chart indicating a process of performing, on a map, mapping and display from the map information associated with the scanned image by using the client terminal and the map management server.

FIG. 11 is a diagram illustrating an example of a table constitution of scan information transmitted from the portable terminal and used for generating the scan ticket.

FIG. 12 is a diagram illustrating an example of a table constitution of the scan ticket generated by the scan ticket server.

FIG. 13 is a diagram illustrating an example of a table constitution of map information data generated based on the scan ticket by the image processing apparatus.

FIG. 14 is a diagram illustrating an example of a table constitution of an authentication table stored by the authentication server.

FIG. 15 is a diagram illustrating an example of a configuration of a ticket issuance screen to be displayed when an input of scan information is accepted by the portable terminal.

FIG. 16 is a diagram illustrating an example of a configuration of a process selection screen to be displayed when an input of a process content is accepted by the image processing apparatus.

FIG. 17 is a diagram illustrating an example of a configuration of a ticket selection screen to be displayed when an input of scan ticket selection is accepted by the image processing apparatus.

FIG. 18 is a diagram illustrating an example of a configuration of a map coordinates selection screen to be displayed when designation of map coordinates is newly accepted by the image processing apparatus.

FIG. 19 is a diagram illustrating an example of a configuration of a registered information preview screen to be displayed when the scanned image registered by the client terminal is displayed on the map.

### DESCRIPTION OF THE EMBODIMENTS

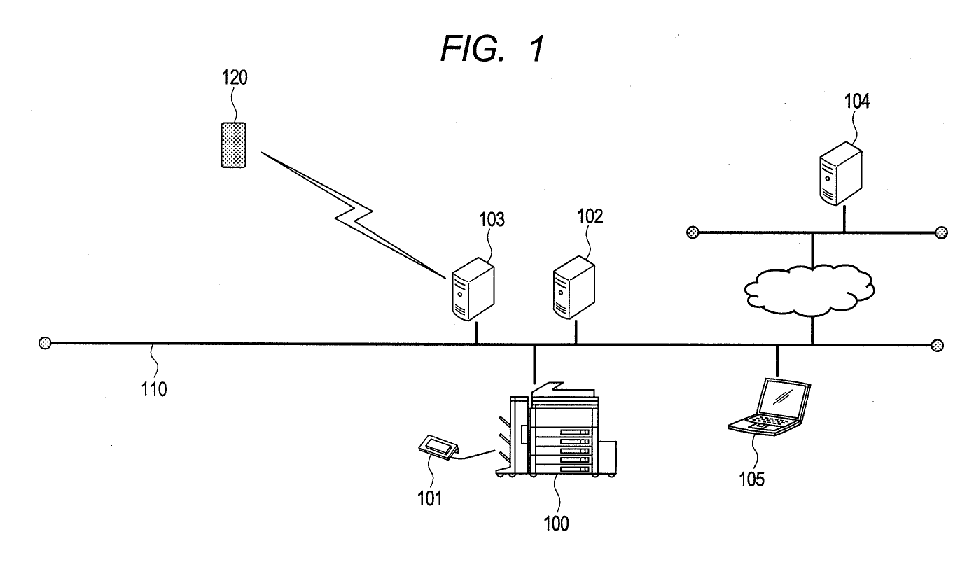

FIG. 1 a configuration diagram illustrating an example of a scan management system according to the embodiment of the present invention. Here, the scan management system includes an image processing apparatus (image reading apparatus) 100, a card reader 101, an authentication server 102, a scan ticket server 103, a map management server 104, a client terminal 105, and a portable terminal 120. Further, the image processing apparatus 100, the authentication server 102, the scan ticket server 103, the map management server 104 and the client terminal 105 are communicably connected to others through a LAN (local area network) 110. Furthermore, the portable terminal 120 is communicably connected to the scan ticket server 103 through a wireless communication means, and the card reader 101 is communicably connected to the image processing apparatus 100. Here, the card reader 101 may be built in the image processing apparatus 100. When the map management server 104 is provided outside the system, the map management server may be communicably connected to other devices through a WAN (wide area network).

In any case, it is needless to say that the terminals, the servers and the apparatus respectively connected to the network illustrated in FIG. 1 are merely one example, whereby various configuration examples may be applied to the scan management system according to intended use and purpose.

The image processing apparatus 100 can read (scan) a paper document, convert the scanned paper document into electronic image data, and transmit the obtained electronic image data to the map management server 104.

The card reader 101, which is connected to the image processing apparatus 100, reads out information from an IC (integrated circuit) card of a user for the purpose of user authentication. Incidentally, the card reader 101 may be provided directly on the image processing apparatus 100. Further, if the user authentication is possible, information which is input from the operation unit of the image processing apparatus 100 may be used.

The authentication server 102 performs the user authentication based on the information read out from the IC card by the card reader 101. Incidentally, the authentication server 102 may be contained in the scan ticket server 103, the map management server 104 or the image processing apparatus 100 (scan management apparatus).

The scan ticket server 103 generates a scan ticket based on the information transmitted from the portable terminal 120. In the present embodiment, the scan ticket (identification information) implies the information, to be displayed on the image processing apparatus 100, for instructing the user to scan various paper documents. When the scan ticket is issued by the scan ticket server 103, the issued scan ticket is received and displayed by the image processing apparatus. Then, the displayed scan ticket is selected by the user, the paper document is scanned based on transmission destination information, scan setting and the like included in the selected scan ticket, and the obtained data is transmitted to a predetermined transmission destination. Incidentally, the scan ticket server 103 may be contained in the authentication server 102 or the map management server 104 (scan management apparatus).

The map management server 104 manages information indicating where the paper document was obtained, based on the scanned image transmitted from the image processing apparatus and various information associated with the transmitted scanned image. Incidentally, the map management server 104 may be contained in the authentication server 102 or the scan ticket server 103 (scan management apparatus).

The client terminal 105 receives various kinds of information stored in the map management server 104, displays on the map the position where the paper document was obtained, and also displays the scanned image of the paper document so that the user can browse it. Incidentally, the client terminal 105 may be contained in the portable terminal 120.

The portable terminal 120 obtains position information indicating the location (position) where the paper document was obtained, generates information for producing the scan ticket, and transmits the generated information to the scan ticket server 103. Incidentally, the portable terminal 120 may be contained in the client terminal 105 (information processing apparatus).

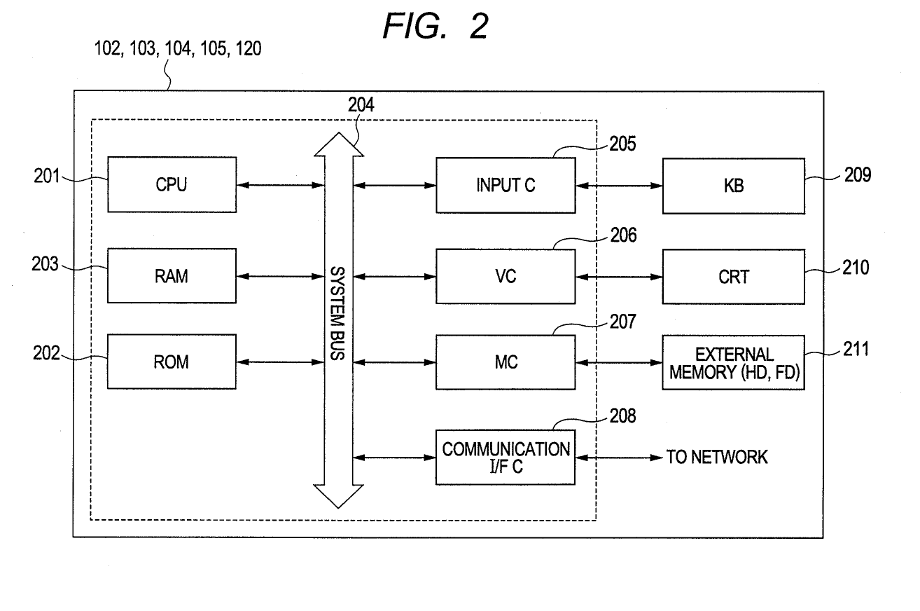

Subsequently, an example of the hardware constitution of each of the authentication server 102, the scan ticket server 103, the map management server 104, the client terminal 105 and the portable terminal 120 will be described with reference to FIG. 2.

In the drawing, a CPU (central processing unit) 201 totally controls devices and controllers respectively connected to a system bus 204. Incidentally, BIOS (Basic Input/Output System) serving as a control program for the CPU 201, an OS (operating system) also serving as a control program, later-described various programs necessary to achieve functions to be performed by each server or each device, and the like are stored in a ROM (read only memory) 202 or an external memory 211.

A RAM (random access memory) 203 serves as a main memory, a working area and the like for the CPU 201. In case of performing a process, the CPU 201 loads a program or the like necessary for the process to the RAM 203, and then executes the loaded program or the like to perform the process to achieve various operations.

An input C (input controller) 205 controls inputs from a KB (keyboard) 209, and a pointing device such as a not-illustrated mouse or the like. In the apparatus which is equipped with a touch panel, the input C 205 is provided on a later-described CRT (cathode ray tube) 210. Thus, various operations can be performed when the CRT 210 is touched. A VC (video controller) 206 controls a display to be performed on a display device such as the CRT 210 or the like. Incidentally, a liquid crystal display may be used as the display device.

An MC (memory controller) 207 controls access to the external memory 211 such as an HD (hard disk), an FD (flexible disk), a CompactFlash™ memory connected to a PCMCIA (Personal Computer Memory Card International Association) card slot through an adapter, or the like, which stores a boot program, browser software, various applications, font data, user files, edit files, various data and the like.

A communication I/F C (communication interface controller) 208, which connects to and communicates with an external apparatus through a network, performs a communication control process on the network. For example, the communication I/F C 208 can perform Internet communication using TCP/IP (Transmission Control Protocol/Internet Protocol). Incidentally, the CPU 201 enables a display on the CRT 210 by, for example, performing an extracting (rasterizing) process of an outline font to a display information region in the RAM 203. Further, the CPU 201 enables a user instruction using a not-illustrated mouse cursor on the CRT 210.

Various programs to be executed in the authentication server 102, the scan ticket server 103, the map management server 104, the client terminal 105 and the portable terminal 120 for achieving the present invention have been recorded in the external memory 211. Then, these programs are loaded to the RAM 203 as necessary, and the loaded programs are executed by the CPU 201. Moreover, definition files on the authentication server 102, the scan ticket server 103, the map management server 104, the client terminal 105 and the portable terminal 120 to be used by the above programs, and various information tables have been stored in the external memory 211. In any case, the definition files and the various information tables will later be described in detail.

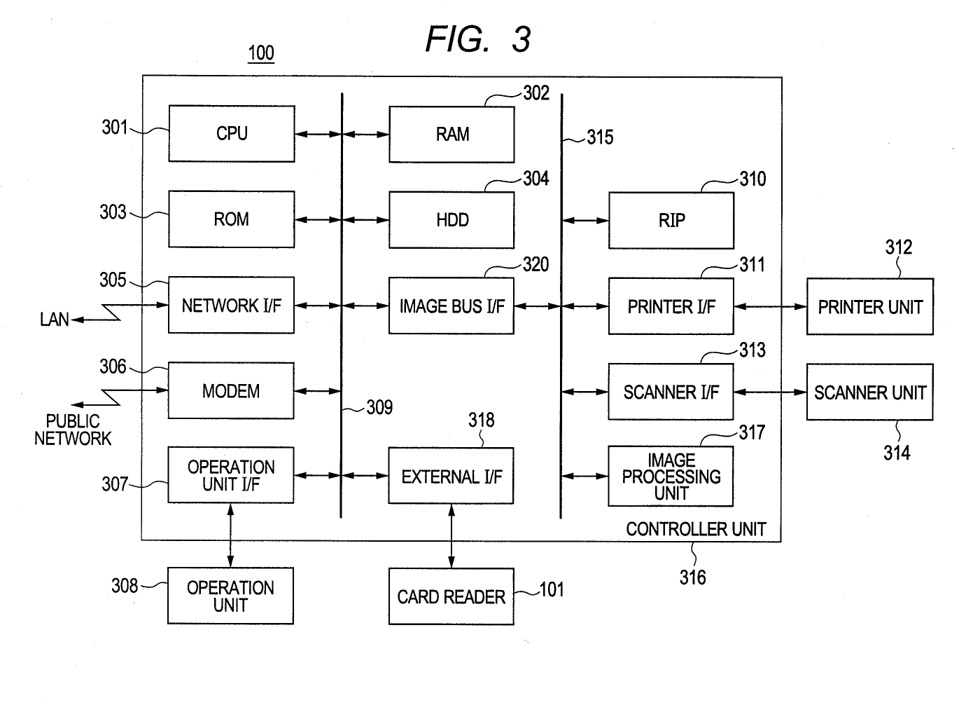

Subsequently, an example of a hardware constitution of the image processing apparatus 100 will be described with reference to FIG. 3.

In FIG. 3, a controller unit 316 is connected to a scanner unit 314 functioning as an image input device and a printer unit 312 functioning as an image output device, and is, on the other hand, connected to the LAN and the WAN, thereby inputting and outputting image data and device information.

In the controller unit, a CPU 301 is the processor which wholly controls the system. A RAM 302 is the system working memory to be used when the CPU 301 operates, the program memory for recording programs, and the image memory for temporarily recording image data.

A ROM 303 stores therein a boot program and various control programs for the system. An HDD (hard disk drive) 304 stores therein various programs for controlling the system, image data, and the like.

An operation unit I/F 307, which is the interface unit for an operation unit 308, outputs the image data to the operation unit 308 to be displayed thereon. Also, the operation unit I/F 307 functions to transfer, to the CPU 301, information (e.g., user information) input from the operation unit 308 by the user of this system. Incidentally, the operation unit 308 is equipped with a display unit having a touch panel. Thus, when buttons displayed on the display unit are depressed (i.e., touched with a finger or the like) by the user, it is possible to issue various instructions.

A network I/F 305, which is connected to a network (LAN), inputs and outputs data. A modem 306, which is connected to the public line (WAN), inputs and outputs facsimile transmission and reception data.

An external I/F 318 is the interface unit which accepts external inputs such as inputs from a USB (universal serial bus), an IEEE (Institute of Electrical and Electronics Engineers) 1394, a printer port, an RS-232C (Recommended Standard 232 version C), and the like. In the present embodiment, the card reader 101 for reading the IC card necessary for the user authentication is connected to the external I/F 318.

Further, the CPU 301 controls information reading from the IC card by the card reader 101 through the external I/F 318, whereby it is possible to obtain information read from the IC card. The above-described devices are disposed on a system bus 309.

An image bus I/F 320 is the bus bridge which connects the system bus 309 to an image bus 315 for transferring image data at high speed, and thus converts a data structure.

Here, the image bus 315 is constituted by a PCI (Peripheral Component Interconnect) bus or an IEEE 1394 bus. In any case, the following devices are disposed on the image bus 315.

An RIP (raster image processor) 310 extracts vector data into bit map image data.

A printer I/F 311 connects the printer unit 312 to the controller unit 316, and thus performs synchronous/asynchronous conversion for image data.

A scanner I/F 313 connects the scanner unit 314 to the controller unit 316, and thus performs synchronous/asynchronous conversion for image data.

An image processing unit 317 corrects, processes and edits input image data, and further performs printer correction, resolution conversion and the like to print output image data. Furthermore, the image processing unit 317 performs rotation of image data, compression and extraction processes to multivalued image data according to a JPEG (Joint Photographic Experts Group) format, and compression and extraction processes to binary image data according to a JBIG (Joint Bi-level Image experts Group) format.

The scanner unit 314 converts an image on a paper original into an electrical signal as raster image data, by irradiating the image and then scanning it with a CCD (charge-coupled device) line sensor. After the paper original was set on a tray of a document feeder, when a reading start instruction by the user is issued from the operation unit 308, the CPU 301 instructs the scanner unit 314 to cause the document feeder to feed and read the paper original one by one, thereby performing an original image reading operation.

The printer unit 312 is the unit for converting the raster image data into an image on a paper, in an electrophotographic method using a photosensitive drum, a photosensitive belt or the like, an inkjet method of directly printing the image on the paper by discharging inks from a micro-nozzle array, or the like. Such a print operation is started in response to an instruction from the CPU 301. Incidentally, the printer unit 312 has a plurality of paper feeding stages for enabling the user to select different paper sizes and/or different paper directions, and a plurality of paper cassettes respectively corresponding to the plurality of paper feeding stages.

The operation unit 308 has an LCD unit on which a touch panel sheet has been applied to display a system operation screen, and transfers, when the displayed key is depressed, position information indicating the position of the depressed key to the CPU 301 through the operation unit I/F 307. Here, various operation keys provided on the operation unit include, for example, a start key, a stop key, an ID key, a reset key, and the like.

Here, the start key on the operation unit 308 is used to start a reading operation of an original image. Two LEDs (light-emitting diodes) consisting of green and red LEDs are provided at the center of the start key, so as to indicate based on a color thereof whether the start key is in a usable state. The stop key on the operation unit 308 is used to stop the operation which is being performed, the ID key on the operation unit 308 is used to input a user ID of the user, and the reset key is used to initialize the setting from the operation unit.

By the above constitution of the image processing apparatus 100, the image data generated by reading the document with the scanner unit 314 can be transmitted to the LAN from the network I/F 305, and the print data received from the LAN can be printed and output by the printer unit 312 through the network I/F 305.

Moreover, the image data generated by reading the document with the scanner unit 314 can be facsimile-transmitted to the public line by the modem 306, and the image data facsimile-received from the public line can be output by the printer unit 312.

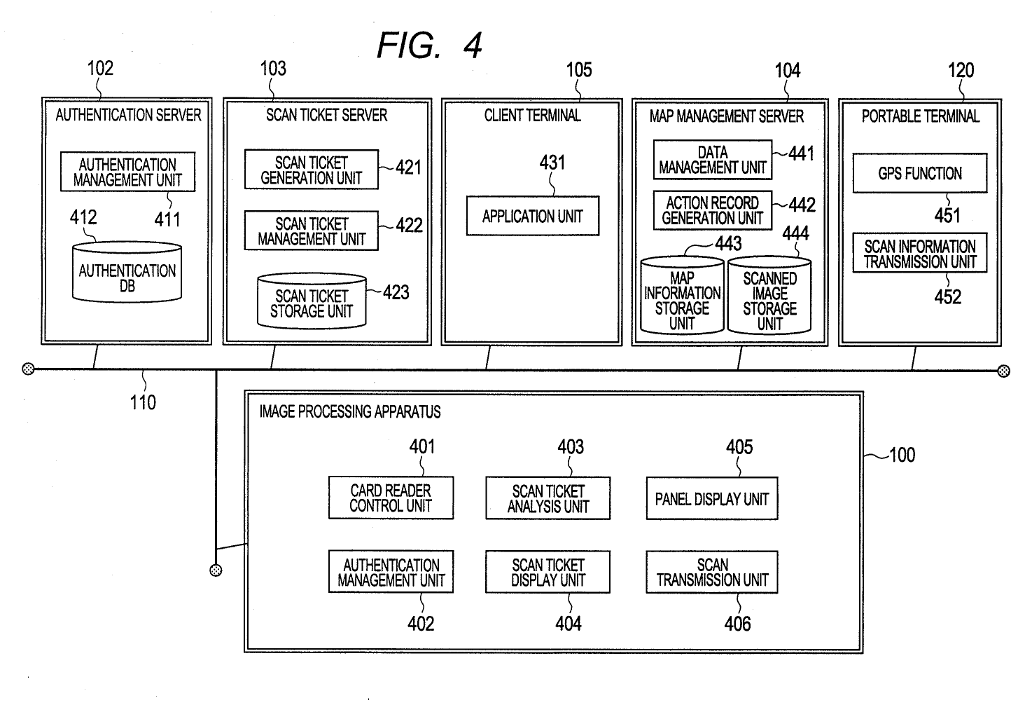

Subsequently, module constitutions of the image processing apparatus 100, the authentication server 102, the scan ticket server 103, the map management server 104, the client terminal 105 and the portable terminal 120 will be described with reference to FIG. 4. Incidentally, the module constitution of each of the apparatus, the terminals and the servers is merely an example, whereby it is needless to say that various kinds of examples can be provided according to intended use and purpose.

The image processing apparatus 100 includes a card reader control unit 401, an authentication management unit 402, a scan ticket analysis unit 403, a scan ticket display unit 404, a panel display unit 405 and a scan transmitting unit 406.

The card reader control unit 401 has a function to communicate with the card reader 101 and thus receive the information of the IC card transmitted from the card reader 101.

The authentication management unit 402 has a function to transmit the information of the IC card received by the card reader control unit 401 to the authentication server 102. In a case where the authentication server 102 is not present in the system, the authentication management unit 402 serves to perform the user authentication instead of the authentication server 102.

The scan ticket analysis unit 403 has a function to analyze the scan ticket of the user transmitted from the scan ticket server 103, and transfer the analyzed scan ticket to the scan ticket display unit 404. Moreover, the scan ticket analysis unit 403 has a function to transfer the information of the analyzed scan ticket to the scan transmitting unit 406.

The scan ticket display unit 404 is a function to receive the scan ticket transferred from the scan ticket analysis unit 403, and display the received scan ticket on the operation unit 308. Moreover, the scan ticket display unit 404 has a function to transfer the information included in the scan ticket selected by the user to, as a scan instruction, the scan transmission unit 406.

The panel display unit 405 has a function to display the menu and the like of the image processing apparatus 100 on the operation unit 308, and accept user's selections.

The scan transmitting unit 406 has a function to transmit, to the map management server 104, the scanned image scanned by the user in the scanner unit 314 together with the information analyzed by the scan ticket analysis unit 403.

The authentication server 102 includes an authentication management unit 411 and an authentication DB (database) 412.

The authentication management unit 411 has a function to receive the information necessary for the user authentication transmitted from the image processing apparatus 100, determine whether or not the relevant user is correct on the basis of the information stored in the authentication DB 412, and then transmit a result of the user authentication to the image processing apparatus 100.

Here, an authentication table 1400 (FIG. 14) necessary for the user authentication has been stored in the authentication DB 412. Thus, the authentication management unit 411 checks if the corresponding information is present in the authentication table 1400.

The authentication table 1400 (FIG. 14), which has been stored in the authentication server 102, includes a user ID 1401 (user information), an IC card ID 1402, a portable terminal ID 1403 and an administrator flag 1404 (administrator information). However, the constitution of the authentication table 1400 is not limited to the above constitution. The user ID 1401 is the information indicating a unique ID allocated to each user, the IC card ID 1402 is the information indicating an ID of the IC card owned by the relevant user, and the portable terminal ID 1403 is the information indicating a unique ID of the portable terminal owned by the relevant user. The administrator flag 1404 is the flag indicating whether or not the relevant user is the administrator. In the present embodiment, it is assumed that the values “0” and “1” in the administrator flag 1404 respectively indicate “general user” and “administrator”. When the “administrator” is set, it is possible to display scan data or the like of a user other than oneself in a later-described step S410.

Incidentally, the function of the authentication server 102 may be provided in the image processing apparatus 100, or in another device. Moreover, the scan management apparatus may be constituted to have all the functions of the authentication server 102, the scan ticket server 103 and the map management server 104.

Further, the scan ticket server 103 includes a scan ticket generation unit 421, a scan ticket management unit 422 and a scan ticket storage unit 423.

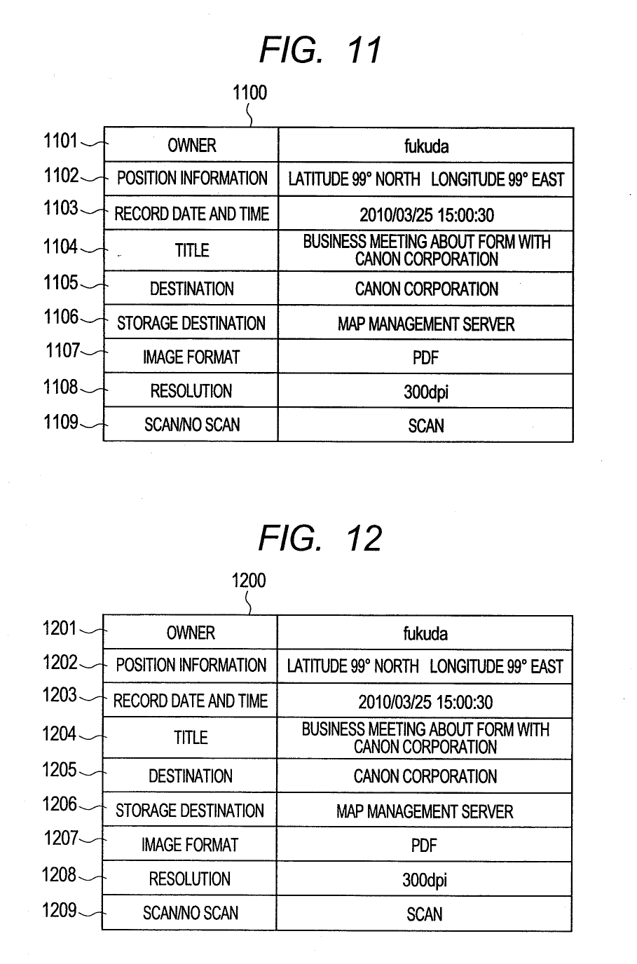

The scan ticket generation unit 421 has a function to generate the scan ticket for issuing a scan instruction to the image processing apparatus 100 on the basis of scan information 1100 (FIG. 11) transmitted from the portable terminal 120.

The scan information 1100, which is input to or generated by the portable terminal 120, includes an owner 1101, a position information 1102, a record date and time 1103, a title 1104, a destination 1105, a storage destination 1106, an image format 1107, a resolution 1108 and a scan/no scan 1109. However, the constitution of the scan information 1100 is not limited to the above constitution. More specifically, the user ID 1401 of the user who issued the scan information 1100 is stored to the owner 1101, the position information obtained in the portable terminal 120 is stored to the position information 1102, and the information indicating year, month, day, hours and minutes of the time when the scan information 1100 was generated is stored to the record date and time 1103. The title 1104 and the destination 1105 are the additional information intended to be recorded to a scan ticket 1200 (FIG. 12). Here, the additional information is not limited to those described above, that is, comments or the like may be added as the additional information. The storage destination to which the data scanned based on the scan ticket has been stored, and the storage destination to which the above additional information has been stored are stored to the storage destination 1106. The information indicating the data format at the time when the paper document was scanned is stored to the image format 1107, and the information indicating the resolution at the time of the paper document scan is stored to the resolution 1108. The flag indicating whether or not the scan is necessary is stored to the scan/no scan 1109.

The scan ticket management unit 422 has a function to store the scan ticket generated by the scan ticket generation unit 421 in the scan ticket storage unit 423, search for the corresponding scan ticket in the scan ticket storage unit 423 in accordance with a request from the image processing apparatus 100, and transmit the searched scan ticket to the image processing apparatus 100.

The scan ticket storage unit 423 stores therein the scan ticket 1200 (FIG. 12) generated by the scan ticket generation unit 421.

The scan ticket 1200 (FIG. 12), which has been stored in the scan ticket server 103, includes an owner 1201, a position information 1202, a record date and time 1203, a title 1204, a destination 1205, a storage destination 1206, an image format 1207, a resolution 1208 and a scan/no scan 1209. However, the constitution of the scan ticket 1200 is not limited to the above constitution. More specifically, the user ID 1401 of the user who issued the scan information 1100 is stored to the owner 1201, the position information obtained in the portable terminal 120 is stored to the position information 1202, and the information indicating year, month, day, hours and minutes of the time when the scan information 1100 was generated is stored to the record date and time 1203. The title 1204 and the destination 1205 are the additional information intended to be recorded to the scan ticket 1200. Here, the additional information is not limited to those described above, that is, comments or the like may be added as the additional information. The storage destination to which the data scanned based on the scan ticket has been stored, and the storage destination to which the above additional information has been stored are stored to the storage destination 1206. The information indicating the data format at the time when the paper document was scanned is stored to the image format 1207, and the information indicating the resolution at the time of the paper document scan is stored to the resolution 1208. The flag indicating whether or not the scan is necessary is stored to the scan/no scan 1209.

Incidentally, the function of the scan ticket server 103 may be provided in the authentication server 102, the map management server 104 or the like. Moreover, the scan management apparatus may be constituted to have all the functions of the authentication server 102, the scan ticket server 103 and the map management server 104.

Further, the map management server 104 includes a data management unit 441, an action record generation unit 442, a map information storage unit 443 and a scanned image storage unit 444.

The data management unit 441 has a function to perform the data registration, the data search and the data transmission for the map information storage unit 443 and the scanned image storage unit 444. Moreover, the data management unit 441 performs the management for the user authentication, as well as the authentication management unit 411.

The action record generation unit 442 has a function to identify in what order the user took actions, from the various information stored in the map information storage unit 443 and the scanned image storage unit 444, and display the identified actions on a map.

The map information storage unit 443 stores therein the image data of the map including the position information. Moreover, the map information storage unit 443 has the authentication table 1400, as well as the authentication DB 412.

The scanned image storage unit 444 stores therein the image scanned using the scan ticket 1200 in the image processing apparatus 100 and the various information included in the scan ticket 1200, while associating the scanned image with the various information (memory unit).

Incidentally, the function of the map management server 104 may be provided in the authentication server 102, the scan ticket server 103 or the like. Moreover, the scan management apparatus may be constituted to have all the functions of the authentication server 102, the scan ticket server 103 and the map management server 104.

The client terminal 105 includes an application unit 431.

The application unit 431 has a function to receive the various information recorded in the map management server 104, and display the scanned image on the map.

Incidentally, the function of the client terminal 105 may be provided in the portable terminal 120 or the image processing apparatus 100.

The portable terminal 120 includes a GPS (global positioning system) function 451, and a scan information transmitting unit 452.

The GPS function 451 is the function to obtain the position information of the portable terminal 120.

The scan information transmitting unit 452 has a function to generate the scan information 1100 based on the position information obtained by the GPS function 451 and the information input from the KB 209 and/or the CRT 210, and transmit the generated scan information to the scan ticket server 103.

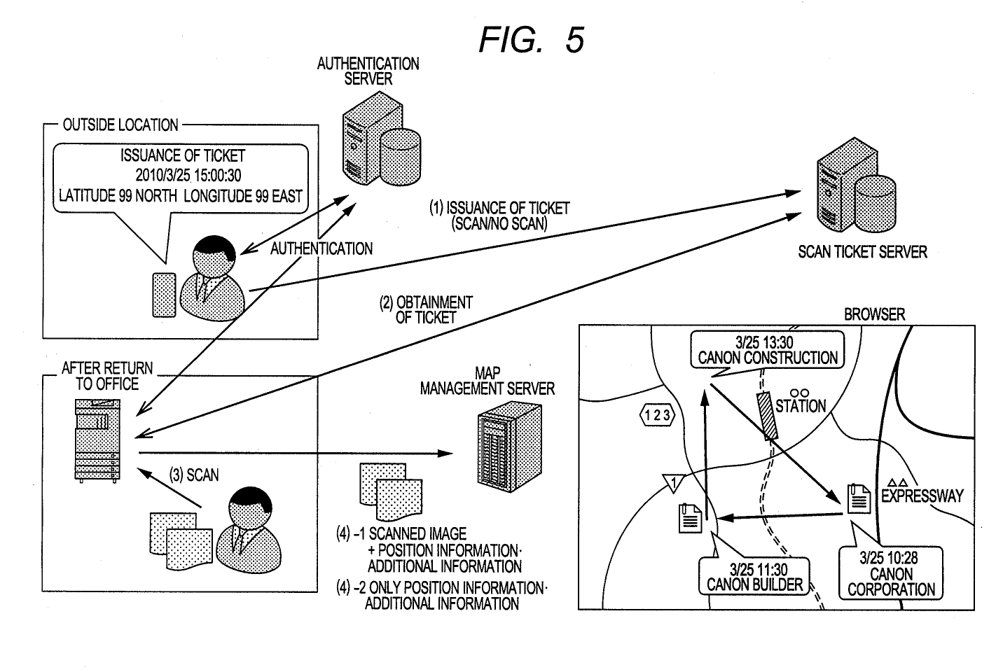

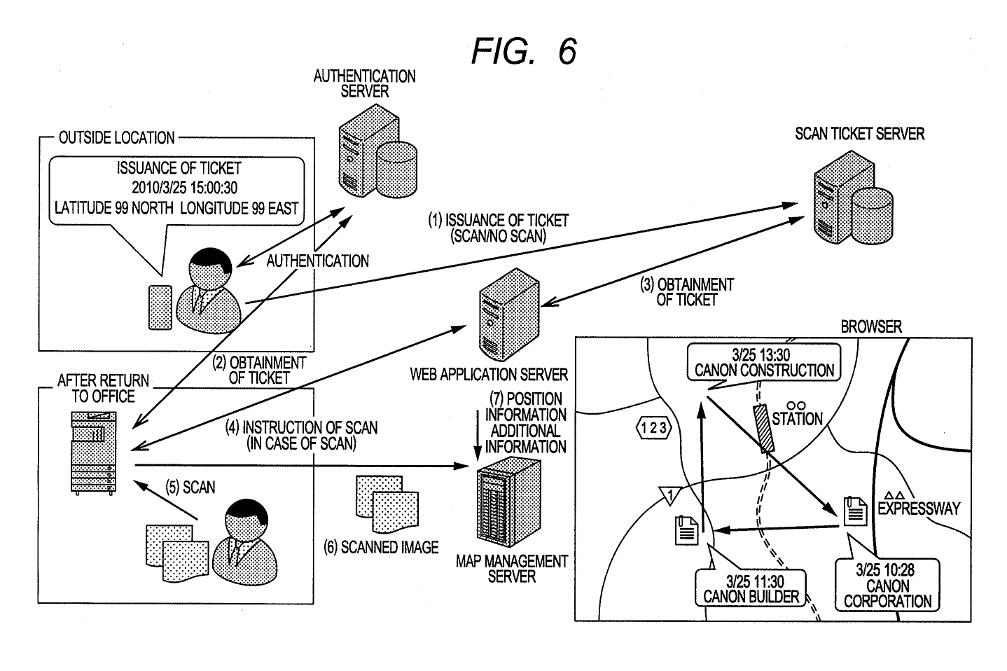

Subsequently, outlines of the processes according to the present embodiment will be described with reference to FIGS. 5 and 6. However, it should be noted that the present invention is not limited to the processes described as below.

The embodiment illustrated in FIG. 5 will be described in due order. In FIG. 5, when the portable terminal 120 starts an application for issuing a scan ticket according to an instruction of a user at an outside location, the application requests authentication to the authentication server 102. When the authentication succeeds, the portable terminal 120 generates the scan information 1100 for issuing the scan ticket together with position information and various information to be registered, and transmits the generated information to the scan ticket server 103. Here, since the position information of the portable terminal is included in the scan information 1100, the position information can resultingly be included in the scan ticket 1200. When the scan information 1100 is received, the scan ticket server 103 generates and stores the scan ticket 1200 based on the received scan information 1100.

Then, when the user returns from the outside location and passes, for login, the own IC card over the card reader 101 provided on the image processing apparatus 100, the image processing apparatus 100 reads the information stored on the IC card and transmits the read information to the authentication server 102. Next, the authentication server 102 performs the authentication process, and, when the authentication succeeds, the image processing apparatus 100 inquires the scan ticket server 103 whether or not the scan ticket 1200 of the user is present. The scan ticket server 103 searches for the scan ticket 1200 of the user, and transmits the corresponding scan ticket 1200 to the image processing apparatus 100. The image processing apparatus 100 receives and displays the transmitted scan ticket 1200. As described above, since the scan ticket 1200 is generated from the scan information 1100 including the position information, the scan ticket 1200 including the position information is resultingly obtained.

The image processing apparatus 100 accepts a selection of the displayed scan ticket 1200, and scans a paper document corresponding to the selected scan ticket. The image processing apparatus 100 transmits a scanned image, the position information included in the scan ticket 1200, and various additional information to the map management server 104. Then, the map management server 104 stores therein the received information.

The client terminal starts a map application for displaying the scanned image and the position information, according to an instruction from the user. Then, the client terminal performs a mapping process on the map based on the scanned image of the user, the position information corresponding to the scanned image, and the additional information. Thus, it is possible to clarify what kind of document was received and where the relevant document was received. Moreover, it is possible, based on the order of issuing of the scan tickets 1200, to know what order the user visited the destinations in. The client terminal has a function to display, when the scanned image was obtained, an icon of the file of the scanned image, and further display, when it is selected by the user, the scanned image itself.

When the portable terminal 120 does not transmit the scan information 1100, the image processing apparatus 100 issues the scan ticket 1200 anew. To do so, the image processing apparatus 100 accepts inputs of various information from the user, generates the scan ticket 1200, and transmits the scanned image, the position information corresponding to the scanned image, and the additional information to the map management server 104.

By the above operation, it is possible to include the position information of the portable terminal in the scan ticket 1200. Therefore, it is possible to store the position information and the scanned paper document (image) while associating them with each other, and to easily confirm them on the map.

FIG. 6 illustrates a modified example of the above-described process illustrated in FIG. 5. In FIG. 6, the scan ticket server 103 and the image processing apparatus 100 exchange the information through a Web application server, and the position information corresponding to the scanned image and the additional information are transmitted from the Web application server to the map management server 104. Usually, since the Web application server has Web applications other than a scan ticket function, it is possible to adopt this modified example as an embodiment.

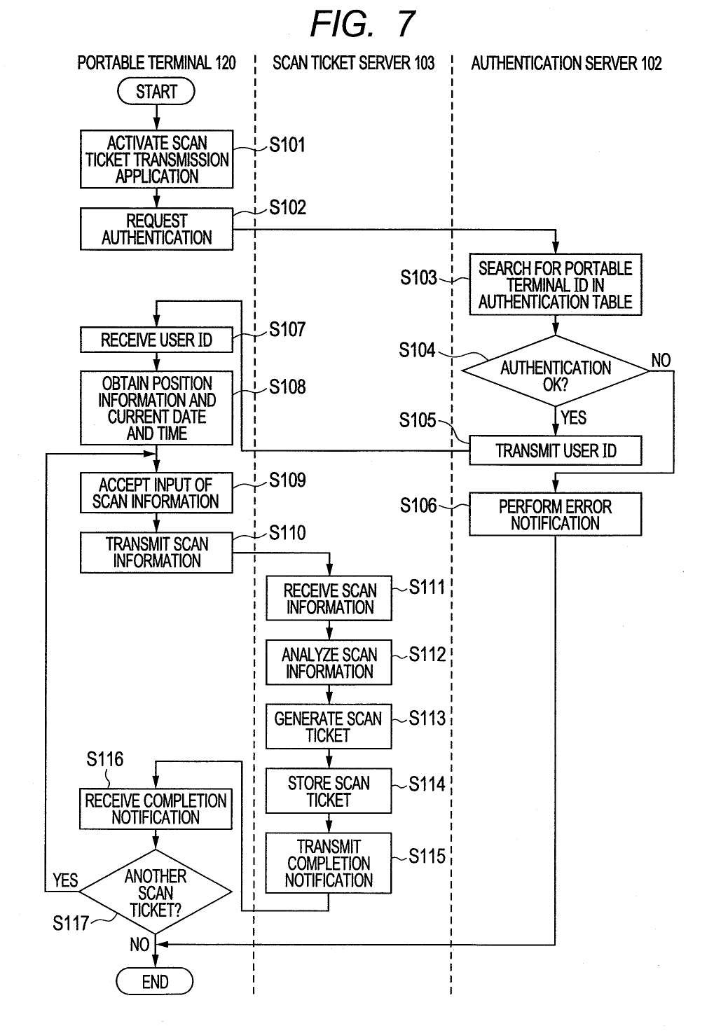

Subsequently, a process of generating and issuing the scan ticket 1200 in the scan ticket server 103 on the basis of the scan information 1100 transmitted from the portable terminal 120 will be described using a flow chart illustrated in FIG. 7.

Incidentally, in the flow chart, processes of respective steps S101, S102, S107 to S110, S116 and S117 are performed under the control of the CPU 201 in the portable terminal 120, processes of respective steps S111 to S115 are performed under the control of the CPU 201 in the scan ticket server 103, and processes of respective steps S103 to S106 are performed under the control of the CPU 201 in the authentication server 102.

In the step S101, the portable terminal 120 activates a scan ticket transmission application stored in the external memory 211 or the like of the portable terminal 120. Here, it is possible as the scan ticket transmission application to use any kind of application if it can accept an input of the scan information 1100 for issuing the scan ticket 1200, receive the position information of the portable terminal 120 by the GPS function 451, and transmit the scan information 1100 for issuing the scan ticket 1200 and the received position information to the scan ticket server 103.

In the step S102, the portable terminal 120 generates an authentication request to the authentication server 102 for the purpose of the user authentication. At this time, the portable terminal 120 transmits the portable terminal ID 1403 stored in the external memory 211 or the like of the portable terminal 120. In the next step, the user authentication is performed by determining whether or not the portable terminal ID 1403 which is coincident with the transmitted portable terminal ID 1403 and is recorded on the authentication table 1400 stored in the authentication server 102 is present.

In the step S103, the authentication server 102 receives the portable terminal ID 1403 transmitted by the portable terminal 120 in the step S102, and determines whether or not the portable terminal ID 1403 coincident with the received portable terminal ID 1403 is present on the authentication table 1400 stored in the authentication DB 412. Then, when it is determined in the step S104 that the portable terminal ID 1403 coincident with the received portable terminal ID 1403 is present on the authentication table 1400, the process moves to the step S105. On the other hand, when it is determined that the portable terminal ID 1403 coincident with the received portable terminal ID 1403 is not present on the authentication table 1400, the process moves to the step S106.

In the step S105, the authentication server 102 transmits, to the portable terminal 120, the user ID 1401 tied to the portable terminal ID 1403 coincident with the received portable terminal ID in the step S103. The user ID 1401 is used to generate the scan information 1100 in the portable terminal 120.

In the step S106, since it was detected in the step S104 that the authentication did not succeed, the authentication server 102 transmits an error notification to the portable terminal 120 so as to notify the portable terminal 120 that the authentication did not succeed.

In the step S107, the portable terminal 120 receives the user ID 1401 from the authentication server 102, and stores the received user ID 1401 in the RAM 203.

In the step S108, the portable terminal 120 obtains the position information indicating the current location (position) of the portable terminal 120 by the GPS function 451 of the portable terminal 120 (position information obtaining unit). Although the position information is the data indicating the latitude and the longitude of the current location in the present embodiment, the present invention is not limited to the above. Moreover, the portable terminal 120 obtains the current date and time from a timer function, and stores the obtained current date and time in the RAM 203. Namely it is possible, by obtaining the current date and time, to set it as the record date and time 1203 of the scan ticket 1200. Moreover, the action record generation unit 442 generates an action record based on the record date and time 1203.

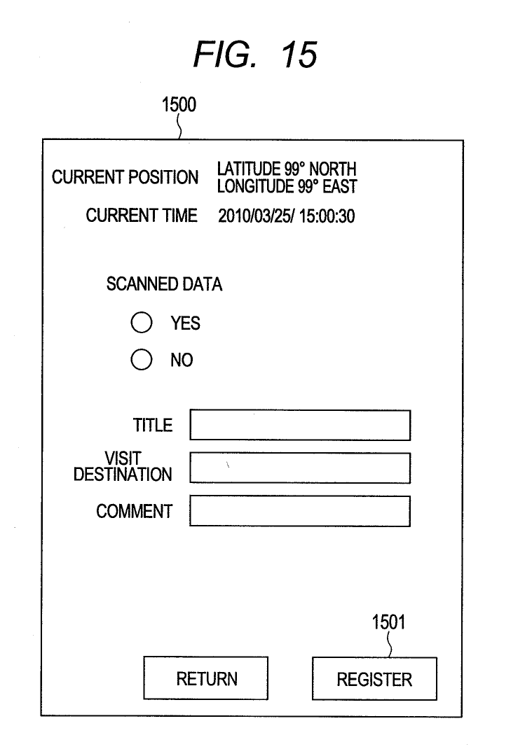

In the step S109, the portable terminal 120 displays a ticket issuance screen 1500 (FIG. 15) on the CRT 210 of the portable terminal 120, and accepts the input of the scan information 1100 (input accepting unit). On the ticket issuance screen 1500, various input forms are provided. For example, the input form for inputting determination as to whether or not to scan a paper document, the input form for inputting visit destinations, and the like are provided. Incidentally, a setting of not scanning the paper document is accepted in the present embodiment because this setting is necessary for the action record generation unit 442 to generate the action record. Here, the setting of not scanning the paper document may include controlling of not transmitting the scan information 1100. Moreover, it is possible, by accepting the input of acceptance information, to know and manage whether or not the paper document was received at the location indicated by the position information obtained in the step S108.

In the step S110, when the input is accepted in the step S109 and a register key 1501 provided on the ticket issuance screen 1500 is depressed, the portable terminal 120 generates the scan information 1100 based on the information input by the user, the user ID 1401 stored in the RAM 203, and the current date and time, and then transmits the generated scan information 1100 to the scan ticket server 103 (position information transmitting unit).

In the step S111, the scan ticket server 103 receives the scan information 1100 transmitted by the portable terminal 120 in the step S110, and stores the received scan information 1100 in the RAM 203.

In the step S112, the scan ticket server 103 reads from the RAM 203 the scan information 1100 received in the step S111, and confirms whether or not the content of the scan information 1100 is insufficient. When it is confirmed that the content of the scan information 1100 is insufficient, the scan ticket server 103 notifies the portable terminal 120 to urge to again input the necessary data. Incidentally, such a confirmation process may be performed on the side of the portable terminal 120.

In the step S113, the scan ticket server 103 generates the scan ticket 1200 based on the scan information 1100 received in the step S111. Although the information to be stored to the scan ticket 1200 is the same as the scan information 1100, additional information may further be stored thereto.

In the step S114, the scan ticket server 103 stores the scan ticket 1200 generated in the step S113, in the scan ticket storage unit 423 of the external memory 211 of the scan ticket server 103.

In the step S115, since the scan ticket 1200 was issued, the scan ticket server 103 transmits a completion notification to the portable terminal 120.

In the step S116, the portable terminal 120 receives the completion notification transmitted from the scan ticket server 103 in the step S115, and notifies the user of this fact on the CRT 210.

In the step S117, the portable terminal 120 accepts a selection as to whether or not to issue another scan ticket 1200. When the selection to issue the scan ticket is accepted, the process returns to the step S109, and the processes in the steps S109 to S116 are repeatedly performed. On the other hand, when the selection not to issue the scan ticket is accepted, the process ends.

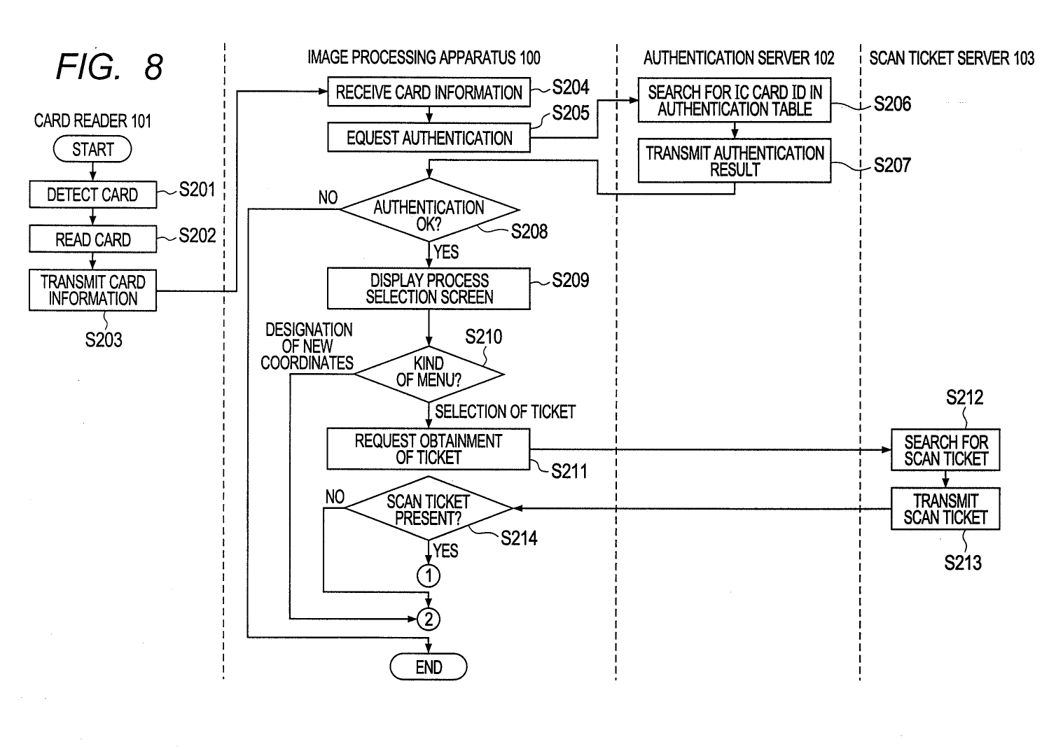

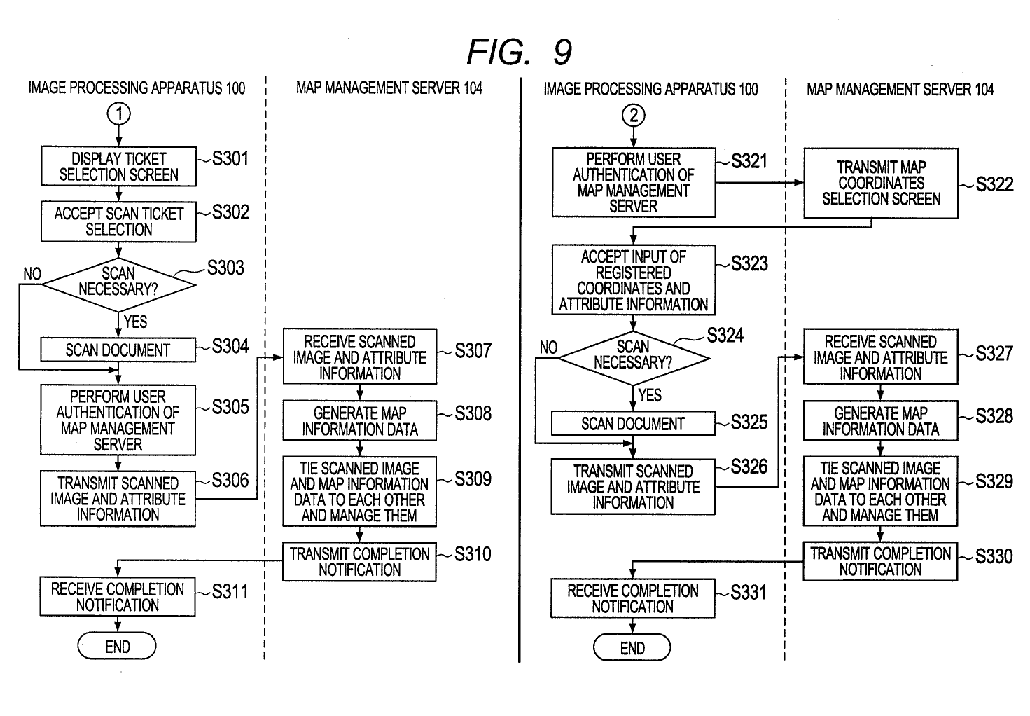

Subsequently, a process of selecting the scan ticket issued by the image processing apparatus, and registering the scanned image and the additional information to the map management server will be described using flow charts illustrated in FIGS. 8 and 9.

Incidentally, in the flow chart of FIG. 8, processes of respective steps S201 to S203 are performed under the control of the card reader 101, processes of respective steps S204, S205, S208 to S211 and S214 are performed under the control of the CPU 201 in the image processing apparatus 100, processes of respective steps S206 and S207 are performed under the control of the CPU 201 in the authentication server 102, and processes of respective steps S212 and S213 are performed under the control of the CPU 201 in the scan ticket server 103.

In the step S201, the card reader 101 detects the IC card passed over by the user.

In the step S202, the card reader 101 reads the IC card ID 1402 stored in the IC card detected in the step S201.

In the step S203, the card reader 101 transmits the IC card ID 1402 read in the step S202 to the image processing apparatus 100 for the purpose of the user authentication.

In the step S204, the image processing apparatus 100 receives the IC card ID 1402 transmitted from the card reader 101 in the step S203.

In the step S205, the image processing apparatus 100 requests the user authentication by transmitting the IC card ID 1402 received in the step S204 to the authentication server 102.

In the step S206, the authentication server 102 receives the IC card ID 1402 transmitted from the image processing apparatus 100 in the step S205, and performs searching so at to determine whether or not the IC card ID 1402 which is coincident with the received IC card ID 1402 is present on the authentication table 1400 stored in the authentication DB 412.

In the step S207, the authentication server 102 transmits a result of the user authentication obtained by the searching in the step S206 to the image processing apparatus 100. When the authentication succeeds, the authentication server 102 includes the user ID 1401 corresponding to the IC card ID 1402 in the result of the user authentication, and transmits the obtained result of the user authentication to the image processing apparatus 100.

In the step S208, the image processing apparatus 100 receives the result of the user authentication transmitted in the step S207, and determines based on the received result whether or not the user authentication succeeded. When it is determined that the user authentication succeeded, the image processing apparatus 100 stores, in the RAM 203, the user ID 1401 included in the result of the user authentication, and the process moves to the step S209. On the other hand, when it is determined that the user authentication did not succeed, the image processing apparatus 100 displays, on the CRT 210, a message or the like indicating the fact that the user authentication did not succeed, and the process ends.

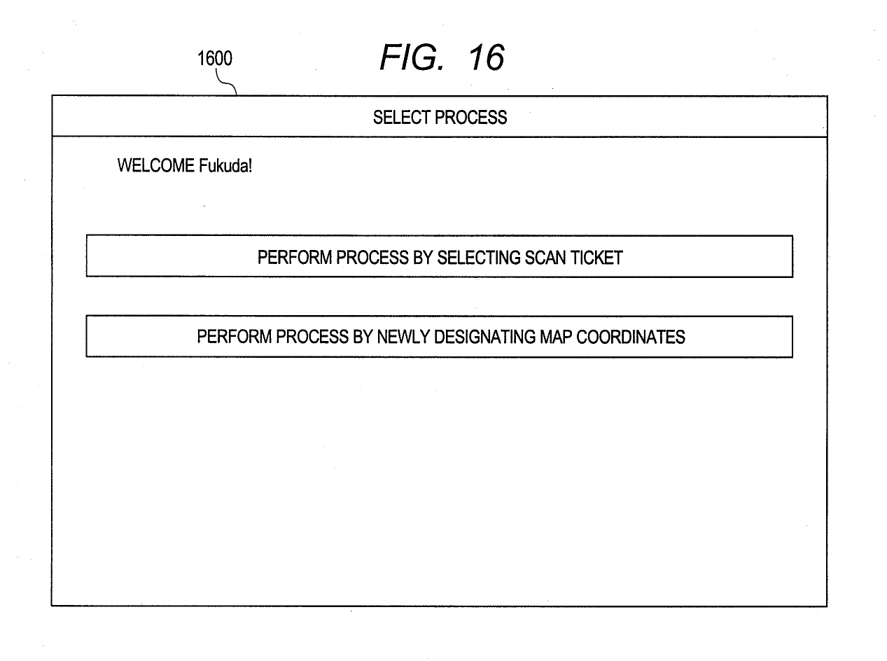

In the step S209, the image processing apparatus 100 displays a process selection screen 1600 (FIG. 16) on the CRT 210 of the image processing apparatus 100, and then accepts a selection from the user. On the process selection screen 1600 in the present embodiment, it is possible for the user to select either a menu for performing the process by selecting the issued scan ticket or a menu for performing the process by newly designating the map coordinates without using the issued scan ticket. However, the configuration of the process selection screen 1600 is not limited to the above configuration.

In the step S210, the image processing apparatus 100 determines what the menu selected by the user is, on the process selection screen 1600 displayed in the step S209 (scan selection accepting unit). When it is determined that the menu of performing the process by selecting the scan ticket was selected by the user, the process moves to the step S211. On the other hand, when it is determined that the menu for performing the process by newly designating the map coordinates was selected by the user, the process moves to a step S321 in FIG. 9.

In the step S211, the image processing apparatus 100 transmits the user ID 1401 stored in the RAM 203 to the scan ticket server 103, and thus requests the scan ticket server 103 to search for the information of the scan ticket 1200 coincident with the transmitted user ID 1401.

In the step S212, the scan ticket server 103 receives the user ID 1401 transmitted in the step S211, and searches for the owner 1201 coincident with the received user ID 1401 from the scan ticket 1200 stored in the scan ticket storage unit 423.

When it is searched in the step S212 that the corresponding scan ticket 1200 is present, in the step S213, the scan ticket server 103 transmits all the corresponding scan tickets 1200 (identification information) to the image processing apparatus 100 (identification information transmitting unit).

In the step S214, the image processing apparatus 100 determines whether or not the scan ticket 1200 was transmitted in the step S213. More specifically, it is determined whether or not the scan ticket 1200 issued by the relevant user was present. Then, when it is determined that the scan ticket 1200 issued by the relevant user was present, the image processing apparatus 100 receives the transmitted scan ticket 1200, and stores the received scan ticket in the RAM 203. Then, the process moves to the step S301. On the other hand, when it is determined that the scan ticket 1200 issued by the relevant user was not present, the image processing apparatus 100 notifies the user that the scan ticket 1200 is not present. Then, the process moves to the step S321 to transition the current menu to the menu for performing the process by newly designating the map coordinates. In the present embodiment, when the scan ticket 1200 issued by the relevant user is not present, the process transitions the menu to the menu for performing the process by newly designating the map coordinates because it is impossible to select the scan ticket 1200. However, the present invention is not limited to the above process. Namely, in such a case, it is possible to return to the step S209 to display the process selection screen 1600, or it is possible to end the process.

Then, the process to be performed subsequent to the process in the flow chart of FIG. 8 will be described with reference to FIG. 9. Incidentally, in the flow chart of FIG. 9, processes of respective steps S301 to S306, S311, S321, S323 to S326, and S331 are performed under the control of the CPU 201 in the image processing apparatus 100, and processes of respective steps S307 to S310, S322, and S327 to S330 are performed under the control of the CPU 201 in the map management server 104.

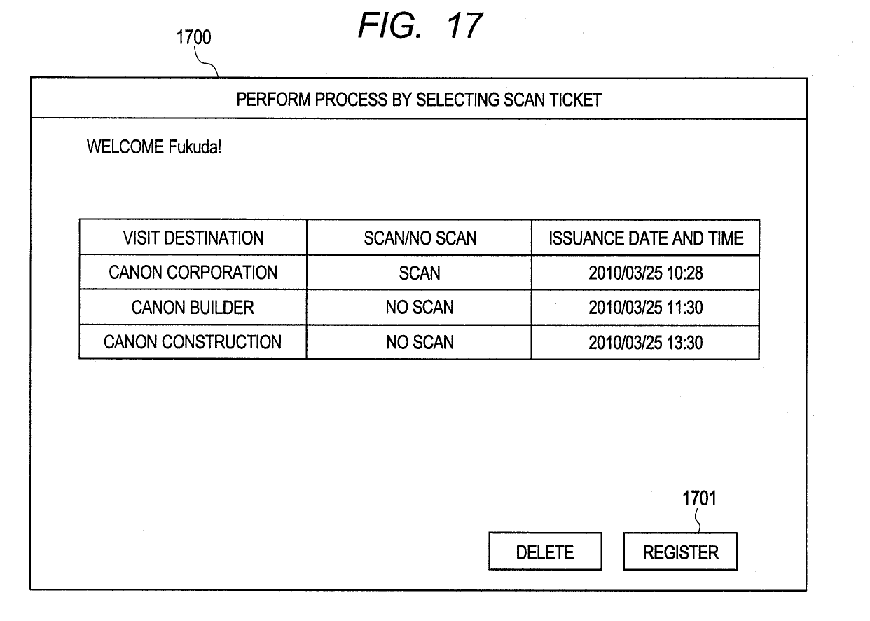

In the step S301, the image processing apparatus 100 creates and then displays a ticket selection screen 1700 (FIG. 17) on the CRT 210 of the image processing apparatus 100, based on the scan ticket 1200 received in the step S214. On the ticket selection screen 1700 in the present embodiment, the destination 1205, the scan/no scan 1209, and the record date and time 1203 of the scant ticket 1200 are displayed. However, the information of the scan ticket 1200 to be displayed on the ticket selection screen is not limited to the above information. Moreover, the configuration itself of the ticket selection screen is not limited to the above configuration.

In the step S302, the image processing apparatus 100 accepts a selection of the scan ticket 1200 from the user, on the ticket selection screen 1700 displayed in the step S301. Here, a plurality of selections of the scant ticket 1200 may be accepted in this step.

In the step S303, the image processing apparatus 100 determines, based on the information of the scan/no scan 1209, whether or not the scan ticket 1200 selected by the user in the step S302 is the scan ticket 1200 to which the scan is necessary. As described above, since the flag indicating whether or not the scan is necessary is stored to the scan/no scan 1209, the above determination can be performed based on the information of this flag. When it is determined that the selected scan ticket 1200 is the scan ticket 1200 which the scan is necessary, the process moves to the step S304. On the other hand, when it is determined that the selected scan ticket 1200 is not the scan ticket 1200 to which the scan is necessary, the process moves to the step S305.

In the step S304, the image processing apparatus 100 notifies the user that the scan is necessary, and the scanner unit 314 of the image processing apparatus 100 accepts a scan instruction of the paper document to be scanned using the selected scan ticket 1200 (document reading unit). Then, the scanner unit 314 performs the scan to the paper document according to the instruction from the user, and generates the scanned image of the relevant paper document according to the image format 1207 and the resolution 1208 included in the scan ticket 1200.

In the step S305, when a depression of a register button 1701 provided on the ticket selection screen 1700 is accepted, the image processing apparatus 100 performs the user authentication for the map management server 104 in order to register the scanned image generated in the step S304 to the map management server 104. Incidentally, since the authentication table 1400 has been stored in the map management server 104 as described above, the user authentication may be performed in the map management server 104. Also, the user authentication may be performed in the authentication server 102.

In the step S306, the image processing apparatus 100 transmits the scanned image scanned in the step S304 and attribute information including the position information 1202 of the scan ticket 1200 to the map management server 104 (scanned data transmitting unit). Here, the attribute information may include any information if it includes the position information 1202. In the present embodiment, it is assumed that the attribute information includes the owner 1201, the record date and time 1203, the title 1204 and the destination 1205, in addition to the position information 1202.

In the step S307, the map management server 104 receives the scanned image and the attribute information transmitted by the image processing apparatus 100 in the step S306, and stores them in the RAM 203. The scanned image is thereafter stored in the scanned image storage unit 444.

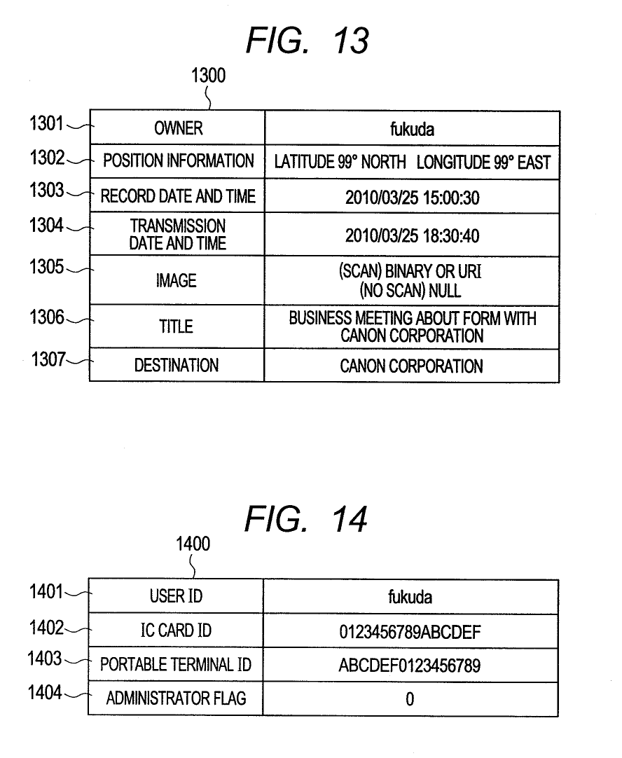

In the step S308, the map management server 104 generates map information data 1300 (FIG. 13) based on the scanned image and the attribute information stored in the RAM 203 in the step S307.

Here, the map information data 1300 (FIG. 13), which is the information generated from the scan ticket 1200, includes an owner 1301, a position information 1302, a record date and time 1303, a transmission date and time 1304, an image 1305, a title 1306 and a destination 1307. Incidentally, the constitution of the map information data 1300 is not limited to the above constitution. More specifically, the user ID stored to the owner 1201 is stored to the owner 1301, the position information stored to the position information 1202 is stored to the position information 1302, the record date and time stored to the record date and time 1203 is stored to the record date and time 1303, and the date and time at which the scan ticket 1200 was transmitted and received by the map management server 104 is stored to the transmission date and time 1304. When the scanned image is present, the binary data of the scanned image or the URI of the destination at which the scanned image has been stored is stored to the image 1305. On the other hand, when the scanned image is not present, a null is stored to the image 1305. The information stored to the title 1204 is stored to the title 1306, and the information stored to the destination 1205 is stored to the destination 1307.

In the step S309, the map management server 104 stores therein the map information data 1300 generated in the step S308 and the scanned image received in the step S307 and stored in the scanned image storage unit 444 while associating them with each other (scanned data storage unit). More specifically, the map information data and the scanned image are tied to each other by storing, to the image 1305 of the map information data 1300, the binary data of the scanned image or the URI of the destination at which the scanned image has been stored. As described above, when the scanned image is not present, the null is stored.

In the step S310, the map management server 104 transmits a completion notification to the image processing apparatus 100.

In the step S311, the image processing apparatus 100 receives the completion notification transmitted from the map management server 104 in the step S310, and notifies the user of the completion of the process. Then, the process ends as a whole. Incidentally, when the plurality of scan tickets 1200 were selected in the step S302, the processes in the steps S303 to S311 are repeatedly performed until the processes of all the selected scan tickets end.

On the other hand, when it is determined in the step S210 that the menu for performing the process by newly designating the map coordinates was selected by the user, or when it is determined in the step S214 that the scan ticket 1200 issued by the user is not present, the process moves to the step S321 to continue the subsequent process.

In the step S321, the image processing apparatus 100 performs the user authentication for the map management server 104 in order to newly designate the map coordinates and register the scanned image to the map management server 104. Incidentally, since the authentication table 1400 has been stored in the map management server 104 as described above, the user authentication may be performed in the map management server 104. Also, the user authentication may be performed in the authentication server 102.

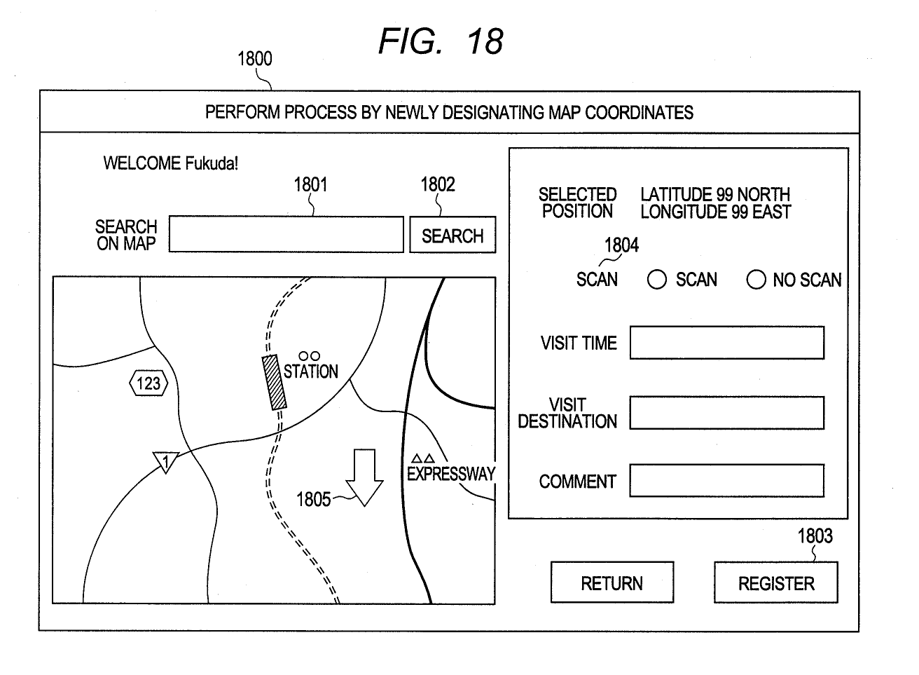

In the step S322, when the user authentication is completed, the map management server 104 creates and transmits a map coordinates selection screen 1800 (FIG. 18) to the image processing apparatus 100.

In the step S323, the image processing apparatus 100 receives the map coordinates selection screen 1800 transmitted from the map management server 104 in the step S322, displays the received map coordinates selection screen 1800 on the operation unit 308 of the image processing apparatus 100, and then accepts an input from the user (position information input accepting unit). Here, the input items provided on the map coordinates selection screen 1800 are substantially the same as those provided on the ticket issuance screen 1500. In addition, an input of the position (location) at which the user received the paper document is accepted on the map according to a designation from the user. Here, a method of searching the map and a method of obtaining the position information are not specifically limited in the present invention. However, in the present embodiment, since the image data of the map including the position information has been stored in the map information storage unit 443, the map coordinates selection screen 1800 including the image data of the map is displayed, and thus a selection of the position (location) by the user is accepted on the map (for example, the selection of the position is accepted in the form of an arrow 1805). Besides, when an address is input to an address searching form 1801 by the user and a depression of a search button 1802 is accepted, the image data of the map corresponding to the input address is displayed.

In the step S324, when a depression of a register button 1803 provided on the map coordinates selection screen 1800 is accepted, the image processing apparatus 100 determines whether or not the scan is necessary, based on a content of an input to a scan necessary/unnecessary setting item 1804 of the map coordinates selection screen 1800. When it is determined that the check box of this item indicating that the scan is necessary is checked, the process moves to the step S325. On the other hand, when it is determined that the check box of this item indicating that the scan is unnecessary is checked, the process moves to the step S326.

In the step S325, the image processing apparatus 100 notifies the user that the scan is necessary, and accepts the scan of the paper document in the scanner unit 314 of the image processing apparatus 100 (document reading unit). Then, the scanner unit 314 performs the scan to the paper document according to an instruction from the user, and thus generates the scanned image of the paper document.

In the step S326, the image processing apparatus 100 transmits the scanned image obtained in the step S325 and the attribute information input by the user in the step S323 to the map management server 104 (scanned data transmitting unit). Here, the attribute information may include any information if it includes the position information 1202.

In the step S327, the map management server 104 receives the scanned image and the attribute information transmitted from the image processing apparatus 100 in the step S326, and stores them in the RAM 203. After then, the scanned image is stored in the scanned image storage unit 444 of the external memory 211.

In the step S328, the map management server 104 generates the map information data 1300 based on the scanned image and the attribute information stored in the RAM 203 in the step S327.

In the step S329, the map management server 104 stores therein the map information data 1300 generated in the step S328 and the scanned image received in the step S327 and stored in the scanned image storage unit 444 while associating them with each other (scanned data storage unit). More specifically, the map information data and the scanned image are tied to each other by storing, to the image 1305 of the map information data 1300, the binary data of the scanned image or the URI of the destination at which the scanned image has been stored. As described above, when the scanned image is not present, the null is stored.

In the step S330, the map management server 104 transmits a completion notification to the image processing apparatus 100.

In the step S331, the image processing apparatus 100 receives the completion notification transmitted from the map management server 104 in the step S330, and notifies the user of the completion of the process. Then, the process ends as a whole.

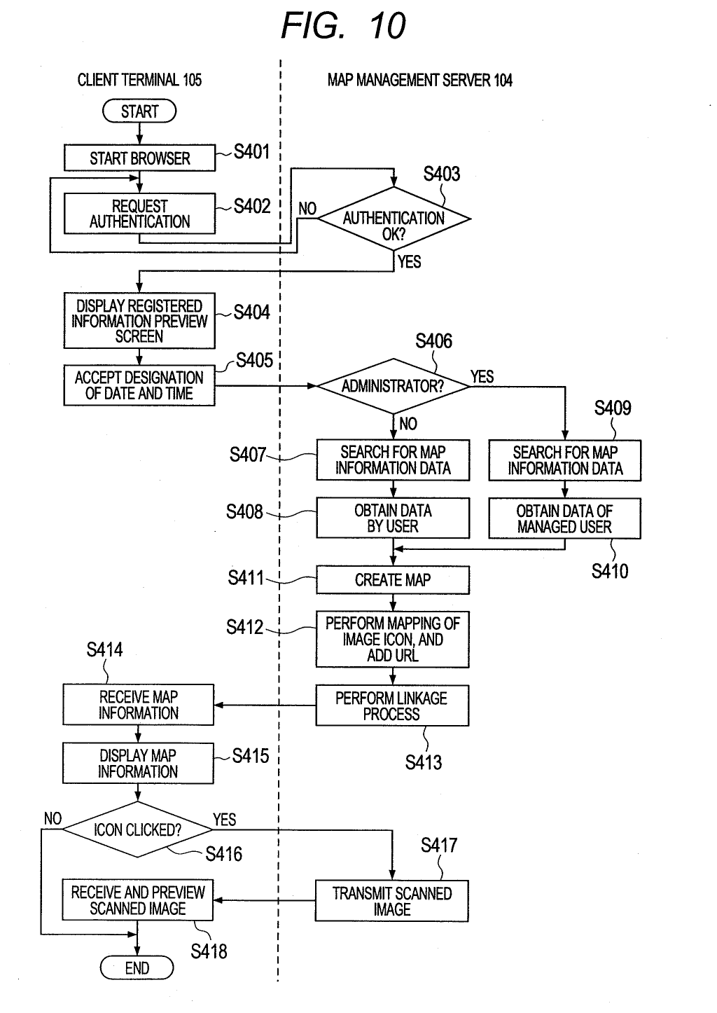

Subsequently, a process, on the side of the client terminal, of referring on the map the scanned image and the map information data registered in the map management server will be described with reference to a flow chart illustrated in FIG. 10.

Incidentally, in this flow chart, processes of respective steps S401, S402, S404, S405, S414 to S416, and S418 are performed under the control of the CPU 201 in the client terminal 105. In the present embodiment, these processes are described as the processes to be performed in the client terminal 105. However, when the potable terminal 120 or the image processing apparatus 100 can communicate with the map management server 104, the above processes may be performed in the potable terminal 120 or the image processing apparatus 100. Moreover, processes of respective steps S403, S406 to S413, and S417 are performed under the control of the CPU 201 in the map management server 104.

In the present embodiment, an example that, on the client terminal 105, the scanned image and the map information data registered in the map management server 104 are referred on the map will be described. However, the image processing apparatus 100 may be used instead of the client terminal 105. In this case, various functions of the client terminal 105 are provided in the image processing apparatus 100, whereby the following processes can be performed.

In the step S401, the client terminal 105 starts up the browser for displaying the scanned image and a map region 1902 on the application unit 431, according to an instruction from the user.

In the step S402, the client terminal 105 requests, on the browser started up in the step S401, the user authentication to the map management server 104. Here, the user authentication may be requested to the authentication server 102 if it can perform the user authentication.

In the step S403, the map management server 104 performs the user authentication requested from the client terminal 105 in the step S402, and determines whether or not the authentication succeeded. Incidentally, since the authentication table 1400 has been stored in the map management server 104 as described above, the user authentication may be performed in the map management server 104. Alternatively, the user authentication may be performed in the authentication server 102. In any case, when it is determined that the user authentication succeeded, the user ID 1401 is transmitted to the client terminal 105, and the process moves to the step S404. On the other hand, when it is determined that the user authentication did not succeed, the process returns to the step S402.

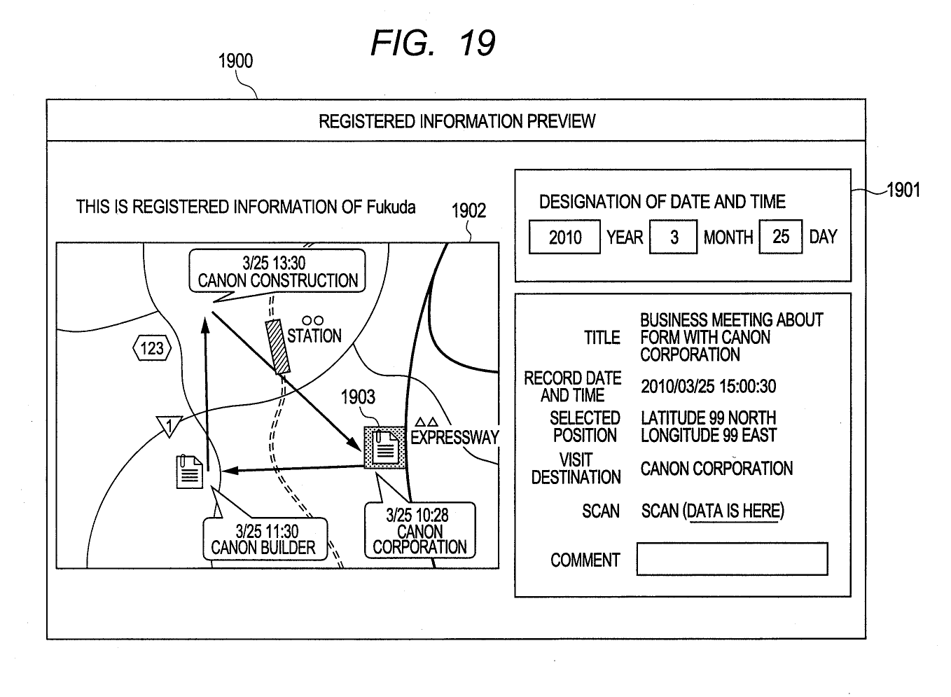

In the step S404, the client terminal 105 displays a registration information preview screen 1900 (FIG. 19) on the CRT 210 so as to accept various inputs from the user. Incidentally, on the registration information preview screen 1900, only a date designation search form 1901 is displayed in its initial state for accepting inputs of dates.

In the step S405, the client terminal 105 accepts the input to the date designation search form 1901 provided on the registration information preview screen 1900 displayed in the step S404, and obtains an input character string according to the input from the user. Then, the obtained character string constituted by the date, and the user ID 1401 transmitted in the step S403 are transmitted to the map management server 104. Incidentally, the date constituting the character string may be designated by actually inputting year, month and date, by specifying a range such as “from when to when”, or by inputting necessary data in a different way.

In the step S406, the map management server 104 identifies, from the authentication table 1400, the user ID 1401 coincident with the user ID 1401 transmitted in the step S405, and determines whether or not “1” has been stored in the administrator flag 1404 of the relevant user ID 1401. Namely, it is determined whether or not the user who requested the search is the administrator. Then, when it is determined that the user who requested the search is the administrator, the process moves to the step S409. On the other hand, when it is determined that the user who requested the search is not the administrator, the process moves to the step S407.

In the step S407, the map management server 104 searches for, in the map information data 1300 stored in the map information storage unit 443, the map information data 1300 coincident with the date input from the user in the step S405.

In the step S408, the map management server 104 obtains, from the map information data 1300 searched for in the step S407, the map information data 1300 having the owner 1301 coincident with the user ID 1401. Namely, it is possible by the processes in the steps S407 and S408 to obtain the map information data 1300 at the date designated by the user.

In the step S409, as well as the process in the step S407, the map management server 104 searches for, in the map information data 1300 stored in the map information storage unit 443, the map information data 1300 coincident with the date input from the user in the step S405.

In the step S410, the map management server 104 obtains, in the map information data 1300 searched for in the step S409, the map information data 1300 having the owner 1301 coincident with the user ID 1401 including the user being the administrator and the user being under the control of the administrator. It should be noted that the user who is the administrator can browse the map information data 1300 of the user who is under the control of the administrator. For example, when a boss is set as the administrator, there is a case where the relevant boss wishes to browse the action history of a subordinate, the scanned image of the material information obtained at the outside location, and the like. The above constitution is available in this case. Thus, it is possible according to the above processes to obtain the map information data 1300 of the user who is the administrator and the map information data 1300 of the user who is under the control of the administrator.

In the step S411, the map management server 104 creates, based on the map information data 1300 obtained in the step S408 or S410, the map (map data), to be displayed on the registration information preview screen 1900, on which various information have been mapped. More specifically, various information are displayed on the map by using the position information 1302, the record date and time 1303, the title 1306 and the destination 1307. In particular, it is determined, by using the position information 1302, where on the map the information is to be displayed. Further, the display magnification of the map is changed so that all the position information 1302 can be browsed. The display magnification can arbitrarily be changed on the screen, and the screen can arbitrarily be moved from side to side and up and down on the map.

In the step S412, when the scanned image has been stored to the image 1305 of the map information data 1300 obtained in the step S408 or S410, the map management server 104 maps and displays the icons and/or the thumbnails of the scanned images on the map created in the step S411 (map data generating unit). In this case, when, e.g., the icon is selected by the user, the link to the scanned image tied to the selected icon is given so that the user can easily browse the relevant scanned image.

In the step S413, the map management server 104 links the icons mapped in the step S412 and the map information data 1300 with others using the symbols such as arrows and the like (linkage process). More specifically, the plurality of map information data 1300 are chronologically linked with others based on the record date and time 1303. Thus, it is possible as the action history to display how the user moved.

Moreover, when the date designation accepted in the step S405 spreads over a plurality of dates, a map different from the map created in the steps S411 and S412 is created, and these maps are mutually linked so as to be able to change over the maps. For example, when “March 25, 2010 to March 31, 2010” is designated in the step S405, the map is created for each date from March 25 to March 30, and the links are given to each map. Then, the map on which the above various information have been mapped is transmitted to the client terminal 105 (map data transmitting unit).

In the step S414, the client terminal 105 receives the map transmitted in the step S413.

In the step S415, the client terminal 105 displays on the map region 1902 the map received in the step S414, and then accepts selections of the icons and the like. When the icon is not displayed here, it means that the paper document has not been received. It is possible to determine, by discriminably displaying with or without the icon whether or not the paper document was received, whether or not the paper document was received at the position on the map to which the icon has been arranged.

In the step S416, the client terminal 105 determines whether or not the icon or the character string being present in the map region 1902 displayed in the step S415 is selected (scanned data obtaining unit). When it is determined that the icon or the character string is selected, a request for obtaining the scanned image is issued to the map management server 104, and the process moves to the step S417. On the other hand, when it is determined that the icon or the character string is not selected, the process ends.

In the step S417, the map management server 104 obtains the scanned image corresponding to the selected icon or the selected character string from the scanned image storage unit 444 on the basis of the link given to the selected icon or the selected character string, and transmits the obtained scanned image to the client terminal 105.

In the step S418, the map management server 104 receives the scanned image transmitted in the step S417, and displays the received scanned image on the CRT 210 of the client terminal 105. For example, when an icon 1903 is selected, the scanned image linked from the icon 1903 is obtained from the scanned image storage unit 444 of the map management server 104, and the obtained scanned image is displayed.

As described above, according to the present embodiment, it is possible at the outside location to instruct to read the image including the position information, and then manage or control the electronic data obtained by the image reading together with the position information included in the electronic data. Therefore, it is possible to have a significant effect of easily managing the scanned data including the position information.

As above, the present embodiment has been described in detail. On the other hand, the present invention can be carried out as a method, a program, a recording medium, and the like.

Moreover, it is needless to say that the present invention includes a case where the functions of the above embodiment can be achieved when the program read from the recording medium is once written in a memory provided in a function expansion board inserted in a computer or a function expansion unit connected to the computer, and then a CPU or the like provided in the function expansion board or the function expansion unit executes a part or all of the actual process according to the instructions of the program.

Moreover, the present invention may be applied to a system consisting of a plurality of devices, or to an apparatus comprising a single device.

Moreover, it is needless to say that the present invention is also applicable to a case where the functions of the above embodiment can be achieved by supplying the program to the system or the apparatus. In this case, the system or the apparatus can have the effects of the present invention when the recording medium storing the program for achieving the present invention is read to the system or the apparatus.

Moreover, the system or the apparatus can have the effects of the present invention when the program for achieving the present invention is downloaded and read from a server, a database or the like on a network by means of a communication program.

Incidentally, the present invention also includes a constitution obtained by appropriately combining the above embodiment and its modifications.

### OTHER EMBODIMENTS

Aspects of the present invention can also be realized by a computer of a system or an apparatus (or devices such as a CPU or MPU) that reads out and executes a program recorded on a memory device to perform the functions of the above-described embodiment, and by a method, the steps of which are performed by a computer of a system or an apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-268685, filed Dec. 1, 2010, and Japanese Patent Application No. 2011-238508, filed Oct. 31, 2011, which are hereby incorporated by reference herein in their entirety.

What is claimed is:

1. A scan management system which includes an information processing terminal comprising a position information obtaining unit adapted to obtain position information indicating a current location of an information processing terminal and a position information transmitting unit adapted to transmit the position information obtained by the position information obtaining unit to a scan management apparatus, an image processing apparatus adapted to generate scanned data by reading a paper document, and the scan management apparatus comprising a memory unit adapted to store the scanned data and the position information corresponding to the scanned data, wherein:
the scan management apparatus comprises
a position information receiving unit adapted to receive the position information transmitted by the position information transmitting unit,
an identification information transmitting unit, in a case where the position information is received by the position information receiving unit, adapted to transmit identification information for associating the position information and the scanned data with each other to the image processing apparatus, and
a scanned data storage unit, in a case where the scanned data generated by the image processing apparatus and the identification information transmitted by the identification information transmitting unit are received from the image processing apparatus, adapted to store, in the memory unit, the received scanned data and the position information corresponding to the received identification information, while associating the scanned data and the position information with each other; and
the image processing apparatus comprises a scanned data transmitting unit adapted to receive the identification information transmitted by the identification information transmitting unit, and transmit the scanned data generated by reading the paper document and the received identification information to the scan management apparatus.

2. The scan management system according to claim 1, wherein:
the scan management apparatus further comprises
a map data generating unit adapted to generate map data by arranging an icon indicating the scanned data on a map, based on the position information corresponding to the scanned data stored in the memory unit, and
a map data transmitting unit adapted to transmit the map data generated by the map data generating unit to the information processing terminal; and
the information processing terminal further comprises a map data display unit adapted to receive the map data transmitted by the map data transmitting unit, and display the received map data.

3. The scan management system according to claim 2, wherein
the position information includes a current date and time when the position information is obtained by the position information obtaining unit, and
the map data generating unit arranges the icon indicating the scanned data on the map based on the position information corresponding to the scanned data stored in the memory unit, and generates the map data so as to be able to identify time-series order in which paper documents being the source of the scanned data were obtained, based on the current date and time.

4. The scan management system according to claim 2, wherein
in the memory unit, administrator information indicating whether or not scanned data of another user can be further displayed is stored for each user,
in a case where the scanned data generated by the image processing apparatus and the identification information transmitted by the identification information transmitting unit are received from the image processing apparatus, the scanned data storage unit stores, in the memory unit, the received scanned data, the position information corresponding to the received identification information, and user information indicating a user who read the scanned data, while associating the scanned data, the position information and the user information with others, and
in a case where a user who instructed the display of the map data determines based on the administrator information that the scanned data of the another user can be displayed, the map data generating unit generates the map data by arranging the icon indicating the scanned data corresponding to the position information on the map based on the position information corresponding to the user information indicating the another user.

5. The scan management system according to claim 2, wherein
the information processing terminal further comprises a scanned data obtaining unit, in a case where the icon indicating the scanned data displayed by the map data display unit is selected by a user, adapted to transmit an obtaining request of the scanned data indicated by the icon to the scan management apparatus, and
the map data display unit displays the scanned data transmitted from the scan management apparatus, by transmitting the obtaining request of the scanned data with the scanned data obtaining unit.

6. The scan management system according to claim 1, wherein
the image processing apparatus further comprises a position information input accepting unit adapted to accept an input of position information according to an instruction from a user, and
in a case where the input is accepted by the position information input accepting unit, the scanned data transmitting unit transmits the position information of which the input was accepted and the scanned data generated by reading the paper document to the scan management apparatus.

7. The scan management system according to claim 2, wherein
in the scan management apparatus, the map data transmitting unit transmits the map data generated by the map data generating unit to the image processing apparatus, and
the image processing apparatus further comprises a map data display unit.

8. The scan management system according to claim 1, wherein the identification information includes a scan ticket in which instruction contents for reading the paper document in the image processing apparatus have been defined.

9. A scan management apparatus which is communicably connected to an information processing terminal which comprises a position information obtaining unit adapted to obtain position information indicating a current location of an information processing terminal and a position information transmitting unit adapted to transmit the position information obtained by the position information obtaining unit to the scan management apparatus, and to an image processing apparatus which receives identification information transmitted from the scan management apparatus and comprises a scanned data transmitting unit adapted to transmit scanned data generated by reading a paper document and the received identification information to the scan management apparatus, and which comprises a memory unit adapted to store the scanned data and the position information corresponding to the scanned data, the scan management apparatus comprising:
a position information receiving unit adapted to receive the position information transmitted by the position information transmitting unit;
an identification information transmitting unit, in a case where the position information is received by the position information receiving unit, adapted to transmit the identification information for associating the position information and the scanned data with each other to the image processing apparatus; and
a scanned data storage unit, in a case where the scanned data generated by the image processing apparatus and the identification information transmitted by the identification information transmitting unit are received from the image processing apparatus, adapted to store, in the memory unit, the received scanned data and the position information corresponding to the received identification information, while associating the scanned data and the position information with each other.

10. A scan management system which includes an information processing terminal, and a scan management apparatus comprising a memory unit adapted to store acceptance information indicating whether or not a paper document was received and position information corresponding to the acceptance information, wherein:
the information processing terminal comprises
a position information obtaining unit adapted to obtain position information indicating a current location of the information processing terminal,
an acceptance information input accepting unit adapted to accept an input of the acceptance information indicating whether or not the paper document was received, and
a management information transmitting unit adapted to transmit the position information obtained by the position information obtaining unit and the acceptance information of which the input was accepted by the acceptance information input accepting unit to the scan management apparatus; and
the scan management apparatus comprises
a management information receiving unit adapted to receive the position information and the acceptance information transmitted by the management information transmitting unit, and
a management information storage unit, in a case where the position information and the acceptance information are received by the management information receiving unit, adapted to store the received position information and the received acceptance information while associating the position information and the acceptance information with each other.

11. The scan management system according to claim 10, wherein the information processing terminal further comprises an acceptance display unit adapted to obtain the position information and the acceptance information stored in the memory unit from the scan management apparatus, and discriminably display whether or not the paper document was received at a location indicated by the position information, based on the position information and the acceptance information.

12. A controlling method for a scan management system which includes an information processing terminal comprising a position information obtaining unit adapted to obtain position information indicating a current location of an information processing terminal and a position information transmitting unit adapted to transmit the position information obtained by the position information obtaining unit to a scan management apparatus, an image processing apparatus adapted to generate scanned data by reading a paper document, and the scan management apparatus comprising a memory unit adapted to store the scanned data and the position information corresponding to the scanned data, the controlling method comprising the steps of:
causing a position information receiving unit of the scan management apparatus to receive the position information transmitted by the position information transmitting unit;
causing an identification information transmitting unit of the scan management apparatus, in a case where the position information was received by the position information receiving unit, to transmit identification information for associating the position information and the scanned data with each other to the image processing apparatus;
causing a scanned data storage unit of the scan management apparatus, in a case where the scanned data generated by the image processing apparatus and the identification information transmitted by the identification information transmitting unit were received from the image processing apparatus, to store, in the memory unit, the received scanned data and the position information corresponding to the received identification information, while associating the scanned data and the position information with each other; and
causing a scanned data transmitting unit of the image processing apparatus to receive the identification information transmitted by the identification information transmitting unit, and transmit the scanned data generated by reading the paper document and the received identification information to the scan management apparatus.

13. A controlling method for a scan management apparatus which is communicably connected to an information processing terminal which comprises a position information obtaining unit adapted to obtain position information indicating a current location of an information processing terminal and a position information transmitting unit adapted to transmit the position information obtained by the position information obtaining unit to the scan management apparatus, and to an image processing apparatus which receives identification information transmitted from the scan management apparatus and comprises a scanned data transmitting unit adapted to transmit scanned data generated by reading a paper document and the received identification information to the scan management apparatus, and which comprises a memory unit adapted to store the scanned data and the position information corresponding to the scanned data, the controlling method comprising the steps of:
causing a position information receiving unit of the scan management apparatus to receive the position information transmitted by the position information transmitting unit;
causing an identification information transmitting unit of the scan management apparatus, in a case where the position information was received by the position information receiving unit, to transmit the identification information for associating the position information and the scanned data with each other to the image processing apparatus; and
causing a scanned data storage unit of the scan management apparatus, in a case where the scanned data generated by the image processing apparatus and the identification information transmitted by the identification information transmitting unit were received from the image processing apparatus, to store, in the memory unit, the received scanned data and the position information corresponding to the received identification information, while associating the scanned data and the position information with each other.

14. A controlling method for a scan management system which includes an information processing terminal, and a scan management apparatus comprising a memory unit adapted to store acceptance information indicating whether or not a paper document was received and position information corresponding to the acceptance information, the controlling method comprising the steps of:
causing a position information obtaining unit of the information processing terminal to obtain position information indicating a current location of the information processing terminal;
causing an acceptance information input accepting unit of the information processing terminal to accept an input of the acceptance information indicating whether or not the paper document was received;
causing a management information transmitting unit of the information processing terminal to transmit the position information obtained by the position information obtaining unit and the acceptance information of which the input was accepted by the acceptance information input accepting unit to the scan management apparatus;
causing a management information receiving unit of the scan management apparatus to receive the position information and the acceptance information transmitted by the management information transmitting unit; and
causing a management information storage unit of the scan management apparatus, in a case where the position information and the acceptance information were received by the management information receiving unit, to store the received position information and the received acceptance information while associating the position information and the acceptance information with each other.

15. A computer-readable recording medium storing a computer program for causing a computer to perform a controlling method for a scan management system which includes an information processing terminal comprising a position information obtaining unit adapted to obtain position information indicating a current location of an information processing terminal and a position information transmitting unit adapted to transmit the position information obtained by the position information obtaining unit to a scan management apparatus, an image processing apparatus adapted to generate scanned data by reading a paper document, and the scan management apparatus comprising a memory unit adapted to store the scanned data and the position information corresponding to the scanned data, wherein:
the computer program causes the scan management apparatus to serve as
a position information receiving unit adapted to receive the position information transmitted by the position information transmitting unit,
an identification information transmitting unit, in a case where the position information is received by the position information receiving unit, adapted to transmit identification information for associating the position information and the scanned data with each other to the image processing apparatus, and
a scanned data storage unit, in a case where the scanned data generated by the image processing apparatus and the identification information transmitted by the identification information transmitting unit are received from the image processing apparatus, adapted to store, in the memory unit, the received scanned data and the position information corresponding to the received identification information, while associating the scanned data and the position information with each other; and
the computer program causes the image processing apparatus to serve as a scanned data transmitting unit adapted to receive the identification information transmitted by the identification information transmitting unit, and transmit the scanned data generated by reading the paper document and the received identification information to the scan management apparatus.

16. A computer-readable recording medium storing a computer program for causing a computer to perform a controlling method for a scan management apparatus which is communicably connected to an information processing terminal which comprises a position information obtaining unit adapted to obtain position information indicating a current location of an information processing terminal and a position information transmitting unit adapted to transmit the position information obtained by the position information obtaining unit to the scan management apparatus, and to an image processing apparatus which receives identification information transmitted from the scan management apparatus and comprises a scanned data transmitting unit adapted to transmit scanned data generated by reading a paper document and the received identification information to the scan management apparatus, and which comprises a memory unit adapted to store the scanned data and the position information corresponding to the scanned data,
wherein the computer program causes the scan management apparatus to serve as:
a position information receiving unit adapted receive the position information transmitted by the position information transmitting unit;
an identification information transmitting unit, in a case where the position information is received by the position information receiving unit, adapted to transmit the identification information for associating the position information and the scanned data with each other to the image processing apparatus; and
a scanned data storage unit, in a case where the scanned data generated by the image processing apparatus and the identification information transmitted by the identification information transmitting unit are received from the image processing apparatus, adapted to store, in the memory unit, the received scanned data and the position information corresponding to the received identification information, while associating the scanned data and the position information with each other.

17. A computer-readable recording medium storing a computer program for causing a computer to perform a controlling method for a scan management system which includes an information processing terminal, and a scan management apparatus comprising a memory unit adapted to store acceptance information indicating whether or not a paper document was received and position information corresponding to the acceptance information, wherein:
the computer program causes the information processing terminal to serve as
a position information obtaining unit adapted to obtain position information indicating a current location of the information processing terminal,
an acceptance information input accepting unit adapted to accept an input of the acceptance information indicating whether or not the paper document was received, and
a management information transmitting unit adapted to transmit the position information obtained by the position information obtaining unit and the acceptance information of which the input was accepted by the acceptance information input accepting unit to the scan management apparatus; and
the computer program causes the scan management apparatus to serve as
a management information receiving unit adapted to receive the position information and the acceptance information transmitted by the management information transmitting unit, and
a management information storage unit, in a case where the position information and the acceptance information are received by the management information receiving unit, adapted to store the received position information and the received acceptance information while associating the position information and the acceptance information with each other.
